(19) United States
(12) Patent Application Publication
(10) Pub. No.: US 2006/0059750 A1
(43) Pub. Date: Mar. 23, 2006

(54) Campaign sign kits and frames for use therewith

(76) Inventor: Steve Schwat, Chevy Chase, MD (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/935,161

(22) Filed: Sep. 8, 2004

(51) Int. Cl. G09F 15/00

(52) U.S. Cl. 40/607.03

(57) ABSTRACT

Campaign signs utilize a display envelope mounted on U-shaped frames. The U-shaped frames are folded prior to shipment so that leg sections of the frames overlie at least one another. The frames are generally sold as kits, each kit having a plurality of folded frames for ease of shipment. The kits may include a stack of bundle of folded frames alone or may include a stack or bundle of folded frames with a number of envelopes which are preferably folded or rolled in order to conserve shipping space. In one embodiment the kit contains a single folded frame and a single display envelope.

### FIELD OF THE INVENTION

The present invention relates to campaign sign kits and frames for use therewith. More particularly, the present invention relates to campaign signs wherein the signs are panels configured as envelopes, which envelopes receive a frame that is embedded in the ground as well as to frames for supporting such signs.

### BACKGROUND OF THE INVENTION

During political campaigns, it is the practice to distribute a large number of campaign signs which are easily erected for display on areas such as lawns, flower beds or other areas into which supports for the signs may be embedded. In one type of campaign sign the supports are U-shaped and are received within envelopes formed by a pair of panels which are joined along three sides thereof with one side open, the open side receiving the wire support frame.

The support frames are usually shipped in lots of twenty-five or more. These frames are various sizes, for example, 14 inches by 22 inches up to, for example, 26 inches by 40 inches. Consequently, a shipment of these frames consumes a substantial area since the frames themselves enclose substantial space. This increases the cost and inconvenience of shipment whether the frames are shipped separately, or in kit form with the envelopes of which the signs are configured.

Once an election is held and a campaign is over, it is necessary to collect and dispose of almost all campaign signs since the signs no longer have a use. Preferably, there is an organized effort to collect both the frames and the display panels for disposal. If the display panels are configured as bags or envelopes then they consume very little room when collected, however the wire supports are U-shaped and therefore consume considerable area when collected. In addition, if the wire supports are preminently U-shaped, they are more difficult to dispose of by residents or property owners.

### SUMMARY OF THE INVENTION

In view of the aforementioned considerations, the present invention is directed to a campaign sign kit comprising first and second panels configured as envelopes having campaign indicia thereon. The kit further includes a rod comprising a horizontal beam section and first and second leg sections, each having a free end for insertion into the ground to support the horizontal beam in spaced relation to the ground. In a preferred embodiment, the first and second leg sections of the rod are joined to the beam section by respective first and second unitary bends. The rod is in a folded configuration while part of the kit and has the first and second legs extending in substantially the same direction as the beam section. The legs are in an overlapping relationship with at least one another, with the bends or with the beam section.

In a further aspect of the invention the first and second unitary bends are U-shaped with curved bights that have end portions disposed at substantially 180° with respect to one another when the rod is in the folded configuration and at 90° with respect to one another when the rod is in an unfolded configuration.

In still a further aspect of the invention, the rod freely maintains the first folded configuration until unfolded to a U-shaped configuration in which the first and second leg sections extend substantially perpendicular to the beam section. The unfolded, U-shaped configuration is freely maintained to provide a support frame for the envelope formed by the first and second panels when the envelope is slid over the support frame.

In still a further aspect of the invention the panels are made of polymer sheet material.

In still a further aspect of the invention the rod is made of malleable metal such as steel or iron having a rust resistant coating.

In still a further aspect of the invention the kit comprises a plurality of envelopes formed by the first and second panels and a plurality of continuous rods in the folded configuration.

In still a further aspect of the invention, the campaign sign kit comprises a single envelope formed of the first and second panels and a single continuous rod in the folded configuration.

In still a further aspect of the invention, the kit is limited to a plurality of the rods in the folded configuration.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 is a front view of an assembled campaign sign configured in accordance with the principles of the present invention;

FIG. 2 is an exploded front view of the campaign sign of FIG. 1 showing an envelope portion of the sign and a frame portion;

FIG. 3 is a side view of FIG. 1 with the envelope shown in elevation;

FIGS. 4A-4C are first, second and third folded configurations for the unfolded frame of FIGS. 1-3;

FIG. 5 is a front view of the frame shown in FIG. 2 which results from unfolding the folded frames of FIGS. 4A-4C;

FIG. 6 is a view of several frames comprising a frame kit;

FIG. 7 is a view of a frame and a folded envelope providing a single campaign sign kit, and

FIG. 8 is a view of a campaign sign kit having numerous frames and numerous display envelopes.

### DETAILED DESCRIPTION

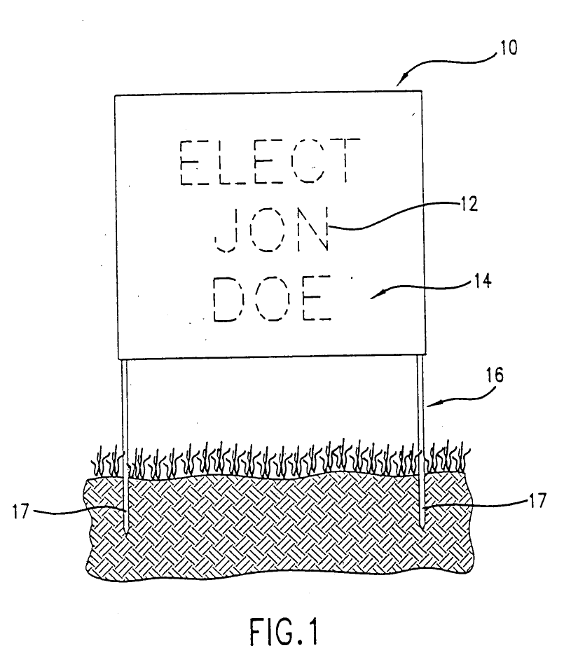

Referring now to FIG. 1 there is shown a campaign sign 10 configured in accordance with the principles of the present invention. The term “campaign sign” refers to a type of sign which is widely used in political campaigns as a “lawn sign” because it is easily erected and easily removed. However, this type of sign may be used in other campaigns or activities such as advertising campaigns for goods or services, such as but not limited to, real estate, yard sales, automobiles or any other type of item or service. These signs may be used by groups or individuals to express points of view and may be used by individuals in lieu of other forms of communication. The signs 10 have two surfaces having indicia 12 thereon, which indicia may be of any form. The indicia 12 may be supplied by the supplier of the sign or may be placed there by the user of the sign when the sign is being supplied to a customer with a blank surface.

As is seen in FIG. 1, the frame 16 has end portions 17 which are inserted into the ground to support the campaign sign 10 in a vertical orientation. Many campaign signs are placed in yards of homes adjacent streets and are held in a vertical orientation by penetration of the ends 17 in the soil of lawns, gardens and the like.

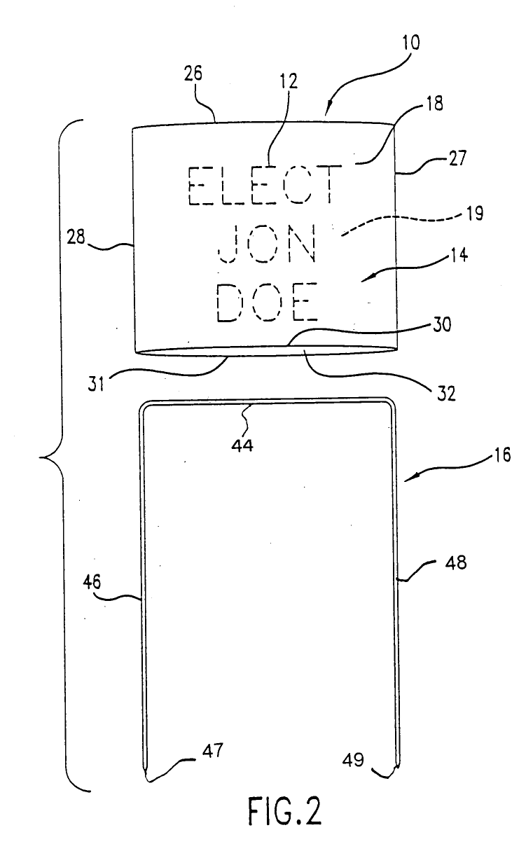

Referring now to FIGS. 2 and 3 as well as FIG. 1, the campaign sign 10 comprises a display envelope 14 and a frame 16 which fits into the display envelope 14. As is seen in FIGS. 2 and 3, the display envelope has a first rectangular panel 18 and a second rectangular panel 19. The indicia 12 is on outwardly facing surfaces 20 and 21 of the first and second panels 18 and 19 respectively, with the inwardly facing surfaces 22 and 23 having the frame 16 received therebetween. Preferably, when the sign is used in a campaign such as a political campaign, the indicia 12 is on both outwardly facing surfaces. In other embodiments, the surfaces 20 and 21 may be blank so the users of the sign may provide their own indicia, or the indicia may be on only one surface. The display envelope 14 is configured by joining the panels 18 and 19 along first, second and third edges 26, 27 and 28 of the panels while keeping the fourth edges 30 and 31 of each of the panels separate to form an opening 32 through which the frame 16 is inserted. The edges 26, 27 and 28 define the sides of the display envelope with the edge 26 being the top edge. The edges of the panels may be formed by attaching the panels 18 and 19 to one another in someway, such as adhering or welding, or by flattening tubular material to form the edges.

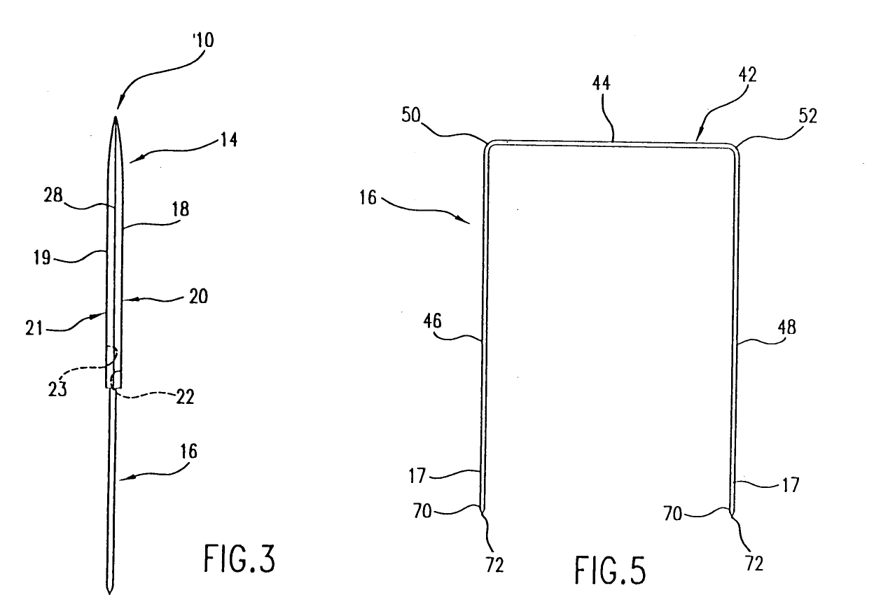

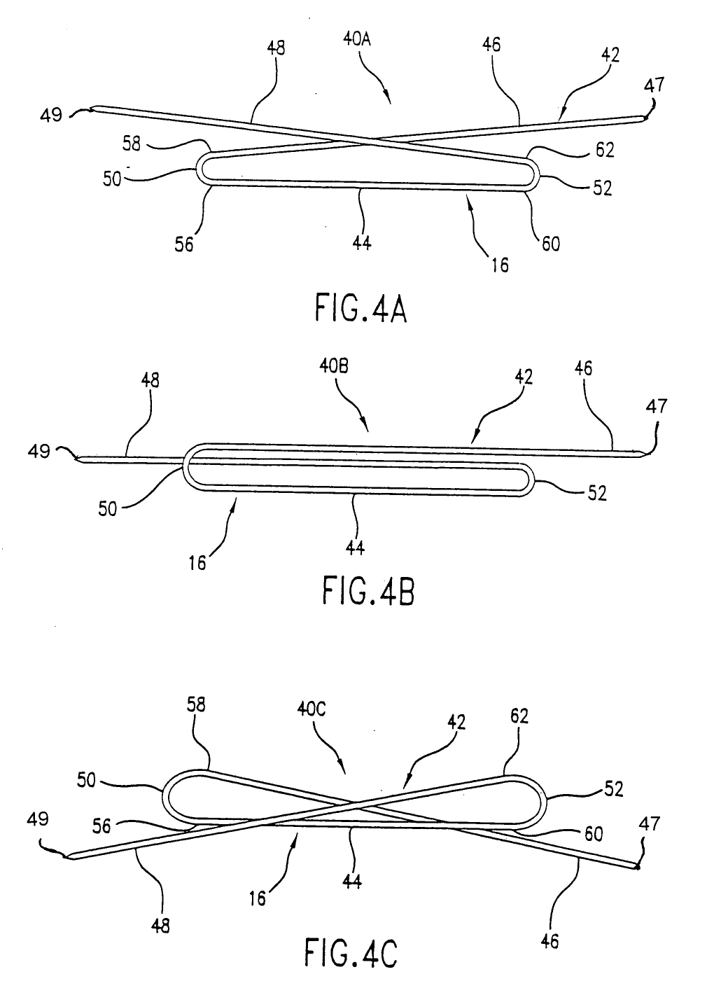

Referring now to FIGS. 4A, 4B and 4C, it is seen that the frame 16 is folded from the U-shape shown in FIG. 2 into a folded configuration 40, which may for example assume the shapes 40a, 40b and 40c. When folded, the frame 16 consumes far less area so that it is in a compact form and can be packaged and shipped to customers more conveniently and less expensively.

The frame 16 is configured from a rod 42 that has a beam section 44, a first leg section 46 and a second leg section 48. The first leg section 46 is joined to the beam section 44 by a first U-shaped bight 50 while the second leg section 48 is joined to the beam section 44 by a second U-shaped bight 52. As is seen in FIGS. 4A-4C, the U-shaped bight 50 has a first end portion 56 which joins the beam section 44, and a second end portion 58 which joins the first leg section 46. The second U-shaped bight 52 is joined to the beam section 44 by a first end portion 60 and to the second leg 48 by a second end portion 62. In FIG. 4A the end portions 56, 58 and 60, 62 extend at an angle slightly less than 180° with respect to one another. In FIG. 4B the end portions 58, 56 and 60, 62 are substantially at about 180° with respect to one another, and in FIG. 4C, the end portions 56, 58 and 60, 62 extend at angles which are at least slightly greater than about 180° with respect to one another. The term “end portions” as used in this description, defines those portions of the U-shaped bights 50 and 52 which join the straight, or substantially straight portions 65, 66 and 67, of the beam section 44 and the first and second leg sections 46 and 48 respectively.

By having the U-shaped bight 50 and 52 shown in FIGS. 4A-4C, persons erecting the signs 10 only have to bend the legs 46 and 48 outwardly so that the frame 16 is U-shaped as illustrated in FIGS. 2 and 5. The bights 50 and 52 therefore predetermine the width of the beam section 44 and lengths of the first and second legs 46 and 48 with respect to the entire length of the rod 42.

Referring now to FIG. 5, when the folded configurations 40A-40C are bent into the U-shaped frame 16, the rod 42 fully maintains the U-shaped form shown in FIG. 5. This is because the rod 42 is made of a malleable material such as zinc coated, carbon steel having high ductility and low elasticity, which rod remains in whatever configuration it is bent and has sufficient rigidity to permit penetration of free end portions 70 into the ground (see FIG. 1) with minimal bending and minimal effort and skill. Exemplary of such a carbon steel is steel having a 1006 carbon content. If the rod 42 is made of steel having a 1006 carbon content with a zinc coating (galvanized steel), then preferably the rod has a diameter of about 9-gauge, although other diameters may be suitable. The rod 42 can also be made of iron with a rust resistant coating. Preferably, the free end portions 70 are frustoconical so that the tips 72 of the end portions have a diameter less than the diameter of the rod 42 from which the frame 16 is formed.

An example of suitable dimensions for the frame 16 are a beam section about 19 inches long and leg sections 46 and 48 of about 30 inches long, with U-shaped bights 50 and 52 that when bent at 90° having extents in the direction of the cross-beam of about 11/4 inch and extents in the direction of the first and second legs 46 and 48 of about 11/4 inch. However, it is pointed out that the frame 16 can have any dimension which is suitable for a campaign sign 10 with the aforedescribed frame being suitable for a display envelope 14 having a width of about 21 inches and a height of about 14 inches. The greater the height of the sign 10, the longer should be the legs 46 and 48 of the frame 16. For example, for a 21 by 14 inch display envelope 14, the leg sections would be in the range of 30 to 34 inches and for a display envelope 14 having a height of about 26 inches, the legs 46 and 48 would have a range of 40 to 50 inches. These dimensions for the frame 16 are examples of frame dimensions for two display envelopes 14, however the dimensions of the display envelope 14 and it's respective frame 16 are not limited to the dimensions used in the foregoing examples.

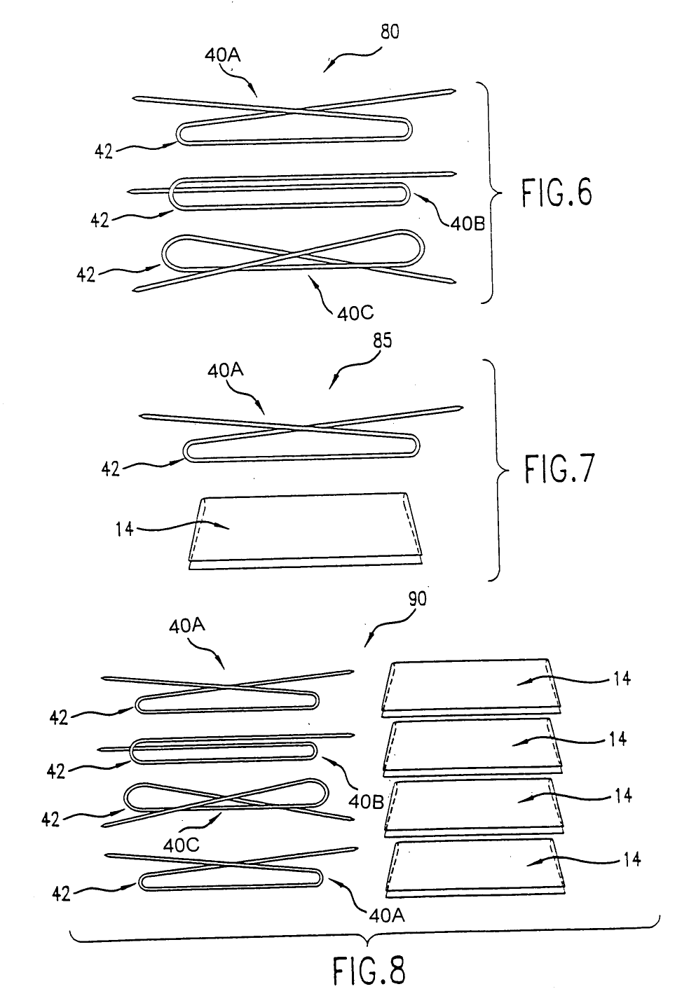

Referring now to FIG. 6, there is shown a kit 80 which has more than one or a plurality of rods 42, i.e., any convenient number of rods 42 in any one, two or all of the folded configurations illustrated by the configurations 40a-40c of FIGS. 4A-4C or variations thereof wherein the leg sections overlap. For example, the kit 80 may include rods 42 in the folded configuration 40 wherein the kit 80 has twenty five frames 16. Other numbers of folded rods 42 for the kit 80 may include more or less than 25 frames, for example, the kit 80 may include 10 frames or 100 frames. The frames 16 are preferably packaged in bundles when provided in kit form.

Referring now to FIG. 7, there is shown another kit 85 that includes a single rod 42 bent in a folded configuration 40 which may have any one, two or all of the folded configurations of FIGS. 4A-4C or variations thereof in which the leg sections overlap, plus one display envelope 14. The display envelope 14 is preferably folded or rolled to consume less area, but in some circumstances may be flat. Preferably, the display envelope 14 is rolled around the folded rod 42. The kit 85 is for a purchaser who needs only one campaign sign 10. The outer surfaces 18 and 19 may be blank for users to provide their own indicia 12 or may have the indicia already thereon.

Referring now to FIG. 8, there is shown a kit 90 which includes a plurality of rods 42 (i.e. more than one or at least two) folded into any one, two or all of the configurations 40a-40c of FIGS. 4A-4C or into variations of those configurations in which the leg sections overlap, plus a plurality of display envelopes 14 which may be folded as shown, may be flat and arranged in a pile or may be rolled around the folded rods. It is preferable that the display envelopes 14 of FIG. 8 are folded or rolled in order to conserve space in the kit 90. Like the frame only kits 80 of FIG. 1, the frames 16 of the kit 90 may be packaged together in bundles.

From the foregoing description, one skilled in the art can easily ascertain the essential characteristics of this invention, and without departing form the spirit and scope thereof, can make various changes and modifications of the invention to adapt it to various usages and conditions.

1. A sign kit for configuring a sign comprising:
at least one display envelope comprising:
first and second panels, each panel having an inwardly facing surface, an outwardly facing surface and four edges,
the first and second panels being joined at three of the four edges thereof to form the display envelope, the fourth edges being separated to form an opening into the display envelope;
indicia placed to be visible on at least one outwardly facing surface of the panels;
at least one continuous rod comprising:
a horizontal beam section and first and second leg sections having free ends for insertion into the ground to support the horizontal beam section in spaced relation to the ground when the sign is erected, the first and second leg sections of the rod being joined to the beam section by respective first and second unitary bends, the continuous rod initially being in a folded configuration when in the kit with the first and second sections extending in substantially the same direction as the beam section with the free ends oriented in substantially opposite directions and being in overlapping relationship with at least with one another.

2. The sign kit of claim 1 wherein the first and second unitary bends are U-shaped with curved bights that have end portions disposed at substantially 180° with respect to one another when the continuous rod is in the folded configuration, the beam section and first leg section of the rod extending from the first unitary bend and the beam section and second leg section of the rod extending from the second unitary bend.

3. The sign kit of claim 2 wherein the metal rod freely maintains the folded configuration until bent to a U-shaped configuration in which the first and second leg sections extend substantially perpendicular to the beam section, the U-shaped configuration being freely maintained to provide a support frame for the envelope formed by the first and second panels when the envelope is slid over the support frame.

4. The sign kit of claim 3 wherein the panels are made of a polymer sheet material.

5. The sign kit of claim 4 wherein the rod is made of malleable metal.

6. The sign kit of claim 5 wherein the malleable metal of the rod is steel or iron having a rust resistant coating.

7. The sign kit of claim 6 wherein the kit comprises:
a plurality of envelopes formed by the first and second panels and a plurality of continuous rods in the folded configuration.

8. The sign kit of claim 6 wherein the kit comprises a single envelope formed by the first and second panels and a single continuous rod in the folded configuration.

9. The sign kit of claim 6 wherein the kit comprises more than one envelope formed of the first and second panels and more than one continuous rod in the folded configuration.

10. The sign kit of claim 1 wherein the kit comprises:
a plurality of display envelopes formed by the first and second panels and a plurality of continuous rods in the folded configuration.

11. The sign kit of claim 1 wherein the kit comprises a single display envelope formed by the first and second panels and a single continuous rod in the folded configuration.

12. The sign kit of claim 1 wherein the kit comprises more than one display envelope formed of the first and second panels and more than one continuous rod in the folded configuration.

13. A campaign sign kit for configuring signs comprising:
a plurality of display envelopes each of which comprises:
first and second panels, each panel having an inwardly facing surface, an outwardly facing surface and four edges,
the first and second panels being joined at three of the edges thereof to form the display envelopes, the fourth edges being separated to form an opening into the display envelopes, and
campaign indicia placed to be visible on at least one outwardly facing surface of each of the panels;
a plurality of continuous rods each of which comprises:
a horizontal beam section and first and second leg sections having free ends for insertion into the ground to support the horizontal beam section in spaced relation to the ground when the signs are erected, the first and second leg sections of each of the rods being joined to the beam section of each rod by respective first and second unitary bends, each of the continuous rods being in a folded configuration with the first and second sections extending in substantially the same direction as the beam section with the free ends oriented in substantially opposite direction and being in an overlapping relationship with at least with one another.

14. The campaign of claim 13 wherein the plurality of display envelopes and continuous rods in the kit number at least about twenty-five display envelopes and at least about twenty-five frames in the folded configuration.

15. A frame for a sign wherein the sign is configured as a rectangular display envelope having first and second panels with a display surface on at least one of the panels, the frame comprising:
a continuous rod having a horizontal beam section and first and second leg sections having free ends for insertion into the ground to support the horizontal beam section in spaced relation to the ground when the sign is erected, the first and second leg sections of the rod being joined to the beam section by respective first and second unitary bends, the continuous rod initially being in a folded configuration when distributed, with the first and second sections extending in substantially the same direction with the free ends oriented in substantially opposite directions as the beam section and being in overlapping relationship with at least with one another, the continuous rod being subsequently being bendable into a U-shaped configuration for use as a support for the display envelope into which the frame is inserted.

16. The frame of claim 15 wherein the continuous rod is formed of malleable iron or steel and has a rust resistant coating.
